(19) United States
(12) Patent Application Publication
(10) Pub. No.: US 2003/0233509 A1
(43) Pub. Date: Dec. 18, 2003

(54) MP3 player and method for operating the same

(76) Inventor: D.C. Chang, Hsin-Chuang City (TW)

Correspondence Address: THE LAW OFFICES OF MIKIO ISHIMARU, 1110 SUNNYVALE-SARATOGA ROAD, SUITE A1, SUNNYVALE, CA, 94087, US

(21) Appl. No.: 10/174,673

(22) Filed: Jun. 18, 2002

(51) Int. Cl. G06F 13/00

(52) U.S. Cl. 710/316

(57) ABSTRACT

A MP3 player and a method for operating the same are proposed. The MP3 player includes a command input device, a bus switch device, and a player control device, and is installed in a computer having a central processing unit (CPU), a hard disk, and a sound output device. In operation, upon receiving a command inputted by the command input device, the bus switch device is urged to connect the hard disk to the player control device, allowing the player control device to read and execute MP3 files stored in the hard disk. As the MP3 player directly reads MP3 files from the hard disk, songs stored in the MP3 files can be more efficiently played. And, the hard disk provides large capacity for storing MP3 files, thereby saving costs for an expensive flash memory used in the prior art.

### FIELD OF THE INVENTION

The present invention relates to MP3 players and methods for operating the same, and more particularly, to a MP3 player installed in a computer to share a hard disk with the computer, and a method for operating the MP3 player.

### BACKGROUND OF THE INVENTION

As a music file compressed as a small-sized MP3 (MPEG Audio Layer-3) file can be easily transmitted through a network, and still produces a fair music quality after the MP3 file is decompressed and executed, MP3 files are getting more widely used in network transmission.

MP3 files (MP3 songs) are usually acquired by downloading from free sites or pay sites on the network. After the MP3 files are downloaded to a hard disk of a computer, they can be executed by a multimedia computer, or by a portable MP3 player after the MP3 files are transferred from the hard disk to the portable MP3 player. Alternatively, the MP3 files can be recorded to a compact disc (CD) and then executed by a CD player.

Typically, MP3 songs are played by a central processing unit (CPU) that decompresses the MP3 files with software. However, such a song-playing method increases loading for the CPU, and also consumes power of a similar amount as to run normal application programs. This is therefore considered to be power-consuming for use with a portable computer such as a notebook computer.

By recording MP3 files to the CD and playing MP3 songs through the use of the CD player, such a method requires a professional CD recorder and a special CD player, as well as a time-consuming recording process, making it cost-ineffective to implement.

As for playing MP3 songs with the portable MP3 player, a flash memory for storing MP3 files in the MP3 player is quite expensive and commonly provided with 32 Mb capacity that can hold only six to eight songs (one song is sized about 3 to 5 Mb). Besides, it is inefficient to transfer the MP3 files from the hard disk to the flash memory of the MP3 player, especially for updating stored songs with new songs being constantly added.

### SUMMARY OF THE INVENTION

An objective of the present invention is to provide a MP3 player and method for operating the same, whereby songs stored in MP3 files can be power-effectively played through the use of the MP3 player.

A further objective of the invention is to provide a MP3 player and method for operating the same, allowing equipment costs to be desirably reduced.

Another objective of the invention is to provide a MP3 player and method for operating the same, making MP3 songs efficiently played without complex manipulation.

In accordance with the above and other objectives, the invention proposes a MP3 player installed in a computer that contains a central processing unit (CPU), a hard disk, and a sound output device. The MP3 player comprises: a command input device for inputting a MP3_ON command; a power control device for controlling power of the MP3 player, wherein the power control device outputs a MP3_ON signal upon receiving the MP3_ON command inputted by the command input device; a bus switch device for switching connection of the hard disk from a bus of the computer to a player control device, when the bus switch device receives the MP3_ON signal outputted from the power control device; and the player control device for retrieving and processing MP3 files stored in the hard disk, allowing the processed MP3 files to be outputted to the sound output device of the computer.

As the above MP3 player directly reads MP3 files from the hard disk of the computer, songs stored in the MP3 files can be more efficiently played, without having to conventionally transfer MP3 files from a computer hard disk to a MP3 player or record MP3 files to a compact disc (CD). Moreover, the hard disk of the computer would provide large capacity for storing MP3 files, thereby saving costs for an expensive flash memory used in the prior art. In addition, compared to the prior art of using a computer CPU for playing MP3 songs, the MP3 player proposed in the invention can more power-effectively operate for song playing.

### BRIEF DESCRIPTION OF THE DRAWINGS

The present invention can be more fully understood by reading the following detailed description of the preferred embodiments, with reference made to the accompanying drawings, wherein:

FIG. 1 is a block structural diagram of a MP3 player according to a first embodiment of the invention;

FIG. 2 is a block structural diagram of a MP3 player according to a second embodiment of the invention; and

FIG. 3 is a block structural diagram of a MP3 player according to a third embodiment of the invention.

### DETAILED DESCRIPTION OF THE PREFERRED EMBODIMENTS

First Preferred Embodiment

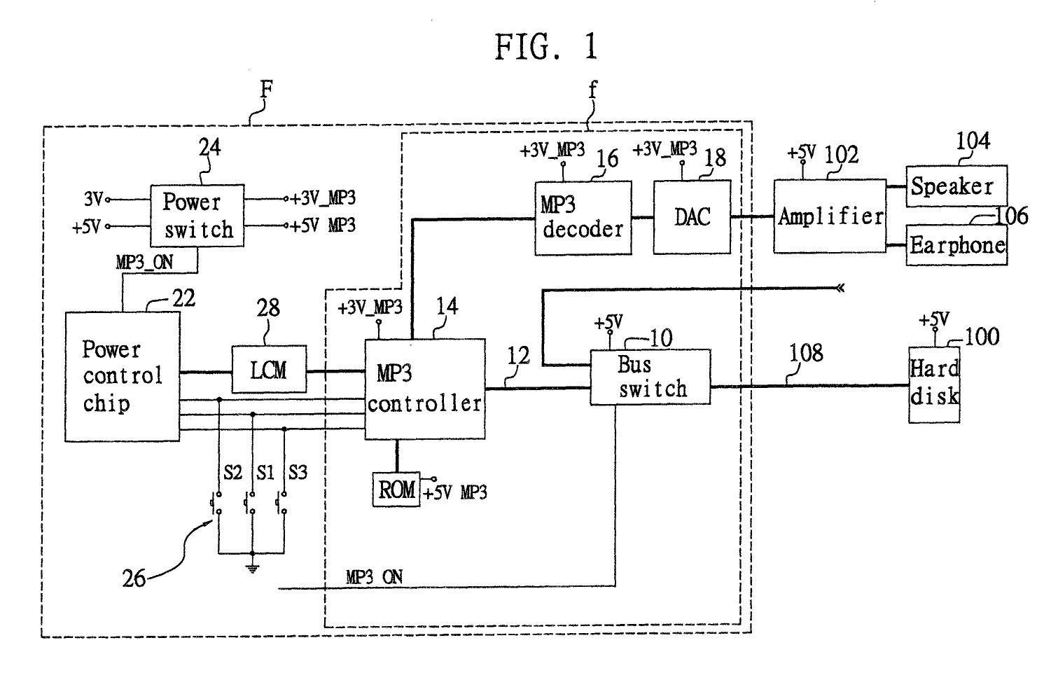

FIG. 1 illustrates a MP3 player according to a first embodiment of the present invention. As shown in FIG. 1, the MP3 player (as encircled by a dotted line F) is installed in a computer having a hard disk 100, an amplifier 102, a speaker 104, earphones 106, and an IDE (Integrated Device Electronics) bus 108, and so on.

The MP3 player comprises: a bus switch 10 connected to the IDE bus 108 that is associated with the hard disk 100; a MP3 controller 14 connected to the bus switch 10 via a bus 12; a MP3 decoder 16 and a digital analog converter (DAC) 18 connected in between the MP3 controller 14 and the amplifier 102; a read-only memory (ROM) 20 connected to the MP3 controller 14; a power control chip 22 connected to the MP3 controller 14; a power switch 24 connected to the power control chip 22; and a plurality of command input keys 26 connected in between the MP3 controller 14 and the power control chip 22.

This embodiment is exemplified with, but not limited to, the IDE bus and IDE hard disk; it is understood that, devices of other specifications such as SCSI (Small Computer System Interface) bus and SCSI hard disk are also suitably adopted in the invention.

Although a playing status of the MP3 player can be directed displayed on a computer monitor (not shown), for the sake of reduce power consumption, a liquid crystal display module (LCM) 28 is preferably provided between MP3 controller 14 and power control chip 22 so as to display the playing status of the MP3 player; this LCM 28 can be a LCM for displaying battery power in a notebook computer.

The command input keys 26 comprise three keys S1, S2, S3 for inputting commands of MP3_ON/MP3_OFF, PREVIOUS TRACK, NEXT TRACK, respectively. The three keys S1, S2, S3 may be keys provided on a computer keyboard (not shown) or newly added to the computer keyboard. It should be understood that, the number of command input keys 26 is not limited to three, but can be flexibly varied depending on practical requirements.

When a user inputs a MP3_ON command via key S1 of the command input keys 26, the power control chip 22 receives the MP3_ON command and immediately outputs a MP3_ON signal to the power switch 24. The power switch 24 connected to a power source (not shown) then supply power such as voltages of +3V, +5V, +3V_MP3, +5V_MP3 to internal devices of the MP3 player, and the hard disk 100 and amplifier 102 of the computer. This arrangement is beneficial of effectively reducing power consumption, as compared to playing MP3 songs through the use of a CPU (central processing unit) of a computer (especially a notebook computer) in the prior art.

Moreover, a common computer is normally provided a power control device that functions the same as the above power control chip 22 and power switch 24. Therefore, the MP3 player proposed in the invention can be adapted to share in the computer's power control device, without essentially using the power control chip 22 and power switch 24, thereby reducing fabrication costs of the MP3 player. Furthermore, when sharing in the computer's power control device, as the MP3 player is provided with its own MP3 controller, MP3 decoder and bus switch that is operationally associated with a hard disk of the computer, therefore MP3 music can be easily played through the use of the MP3 player even if the computer is in a power saving or standby mode; this advantage rather reduces power consumption as compared to the prior art.

The MP3_ON signal outputted from the power control chip 22 to the power switch 24, is also directed to the bus switch 10, whereby the bus switch 10 is urged to switch connection of the hard disk 100 to the MP3 controller 14 via the bus 12, such that the MP3 controller 14 is capable of reading data stored in the hard disk 100.

The MP3 controller 14 is operated by a control program stored in the read-only memory (ROM) 20. The MP3 controller 14 is adapted to read index data of MP3 music files from the hard disk 100, and display the index data on the LCM 28 or a computer monitor. Then, the user can select desirable MP3 songs from the displayed index data by operating key S1 “MP3_ON/MP3_OFF”, key S2 “PREVIOUS TRACK” and/or key S3 “NEXT TRACK”.

Once the MP3 songs are selected by the user, MP3 files corresponding to the selected MP3 songs would be retrieved from the hard disk 100 by the MP3 controller 14, and transmitted to the MP3 decoder 16 for being decoded into digital signals. Then, the digital signals are converted to analog signals by the DAC 18, and outputted through the amplifier 102 to the speaker 104 or earphones 106. Preferably, the index data and MP3 files can be stored in a predetermined region in the hard disk 100, so as to simplify the file retrieval process performed by the MP3 controller 14, and to reduce requirements in processing speed of the MP3 controller 14 and memory capacity of the ROM 20, thereby helping decrease fabrication costs of the MP3 player.

As described above, the power control chip 22, power switch 24, command input keys 26 and LCM 28 used in the MP3 player may all be shared with the computer; therefore, the MP3 player can be even simplified to a structure encircled by a dotted line f in FIG. 1. Furthermore, the bus switch 10, MP3 controller 14, MP3 decoder 16, DAC 18 and ROM 20 encompassed by the dotted line f may be commercially-available standardized products, or alternatively integrated to form a single integrated circuit (IC).

Second Preferred Embodiment

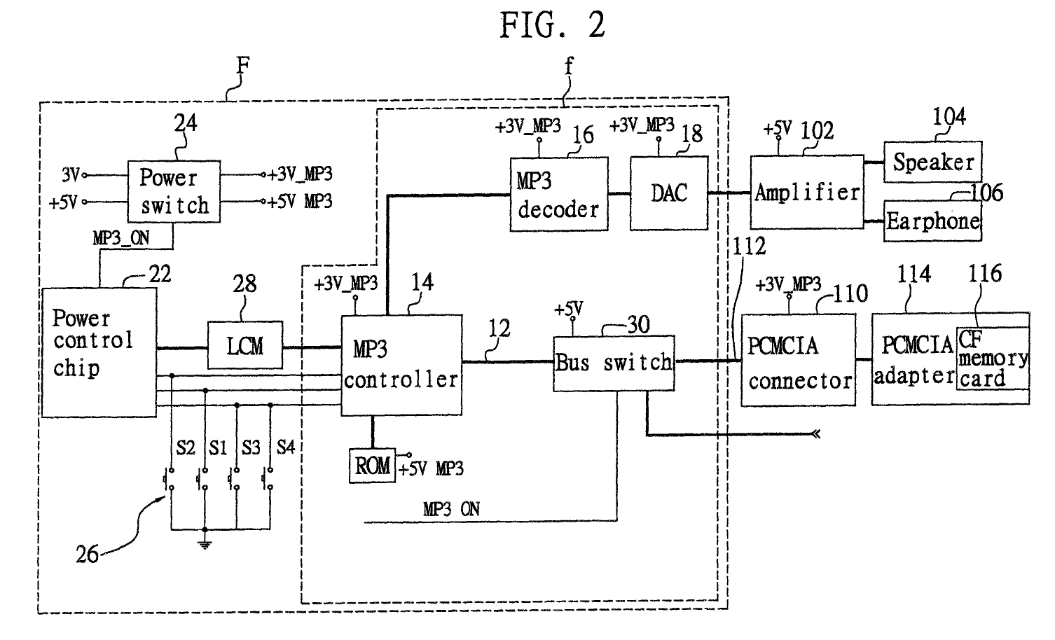

FIG. 2 illustrates a MP3 player according to a second embodiment of the invention. The MP3 player of the second embodiment is specifically applied to a portable computer such as a notebook computer. This second embodiment is similar in structure to the first embodiment except that, as shown in FIG. 2, a bus switch 30 is provided on a memory card bus 112 that is directed to a PCMCIA connector 110 in the notebook computer with a PCMCIA interface, wherein the bus switch 30 is also connected via the bus 12 to the MP3 controller 14.

Therefore, by switching effect provided from the bus switch 30, the MP3 controller 14 is adapted to be capable of reading MP3 files stored in CF (compact flash) memory card 116 of a PCMCIA adapter 114. It should be understood that, besides the CF memory card 116, other memory cards e.g. smart media card are also suitably adopted herein.

Third Preferred Embodiment

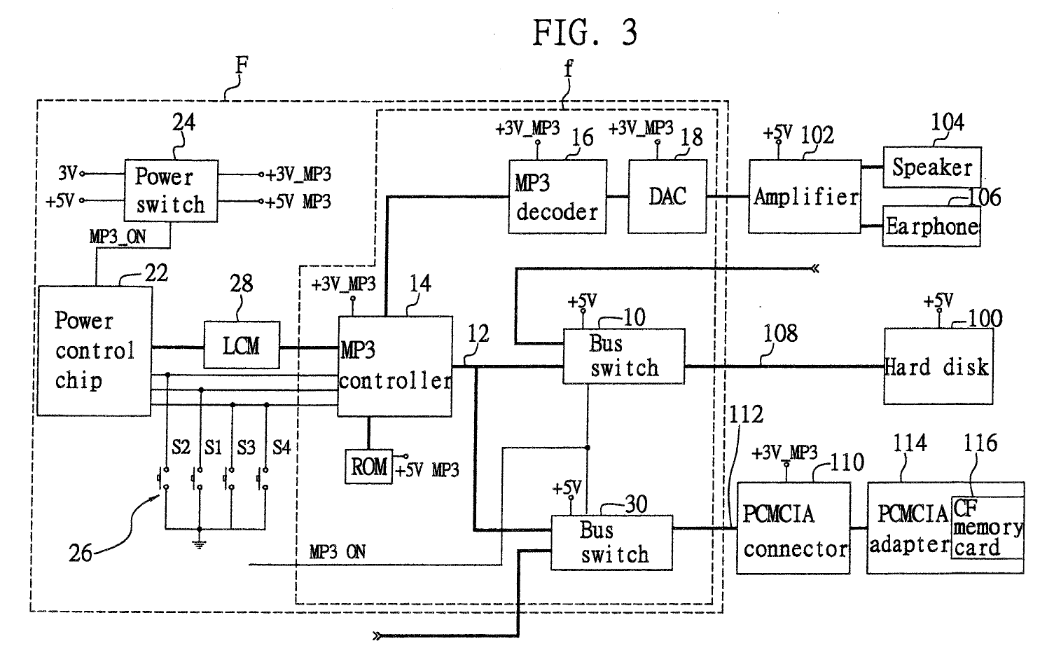

FIG. 3 illustrates a MP3 player according to a third embodiment of the invention. This third embodiment is a combination of the first and second embodiments in a manner that, the MP3 player of this embodiment is capable of executing MP3 files stored in a hard disk or memory card of a computer, to be thereby specifically applied to a portable computer such as a notebook computer.

As shown in FIG. 3, for the MP3 controller 114 of the MP3 player being operating to read MP3 files from the hard disk 100 or CF memory card 116, the command input keys 26 are provided with an additional key S4 that determines an option for the MP3 controller 114 to function with the hard disk 100 or the CF memory card 116, in terms of the MP3_ON signal being at a high or low threshold. In other words, if the bus switch 10 is set to operate at the high threshold, and the bus switch 30 is set to operate at the low threshold, the MP3_ON signal is at the high threshold when the hard disk 100 is chosen via the key S4; alternatively, the MP3_ON signal is at the low threshold when the CF memory card 116 is of the choice.

Similarly, it should be understood that, besides the CF memory card 116, other memory cards e.g. smart media card are also suitably adopted herein.

Method for Operating MP3 Player

A method for operating the above MP3 player with reference to the first embodiment (FIG. 1), comprises the following steps.

The first step is to install the MP3 player in a computer having a CPU (central processing unit, not shown), a hard disk 100 and a sound output device (e.g. amplifier 102, speaker 104 or earphones 106), wherein the MP3 player comprises a command input device (command input keys 26), a bus switch device (bus switch 10), and a player control device (MP3 controller 14 etc).

The next step is to store MP3 files in the hard disk 100 of the computer.

Then, a MP3_ON command is inputted by the command input device.

After that, connection of the hard disk 100 is switched from a bus 108 of the computer to the player control device by the bus switch device, when the bus switch device receives the MP3_ON command inputted by the command input device.

Finally, the MP3 files stored in the hard disk 100 are retrieved and processed by the player control device, allowing the processed MP3 files to be outputted to the sound output device of computer.

It should be understood that, the above operating method is also applied to the MP3 player according to the second and third embodiments of the invention.

In conclusion, the above-described MP3 player according to the invention provides the following advantages in comparison with the prior art.

First, the MP3 player independently has a MP3 controller, decoder and bus switch that is operationally associated with a hard disk of a computer; therefore, for executing MP3 files or playing MP3 songs, it only needs to supply power to the MP3 controller, decoder, and the hard disk and amplifier of the computer, thereby significantly reducing power consumption as compared to the prior art of using a CPU for MP3-song playing.

Further by the above power saving advantage, the MP3 player according to the invention is well applicable to a portable computer such as a notebook computer in no concern of quick use-up of battery power thereof. And, such a notebook computer beneficial for use as a portable MP3 player without having to purchase an additional separate MP3 player, thereby saving equipment costs.

As the MP3 player shares in the hard disk of the computer, compared to the prior art of using an expensive flash memory with limited capacity, the MP3 player is beneficial of saving equipment costs and allows more MP3 songs to be stored in the cheap hard disk capacity up to decades of gigabytes (Gb).

MP3 files are usually downloaded from a network (e.g. Internet) to the hard disk; in comparison with transferring the downloaded MP3 files to a flash memory of a conventional MP3 player or recording the downloaded MP3 files into a compact disc (CD), the MP3 player according to the invention is therefore more advantageous of directly executing the MP3 files downloaded to the hard disk.

Moreover, the MP3 player according to the invention can share in the hard disk, keys, amplifier, speaker, power control device of the computer; this thereby greatly reduces fabrication costs of the MP3 player. And, the MP3 player has its own MP3 controller and decoder, and thus is capable of playing MP3 songs even if the computer is in a power saving or standby mode.

In addition, with MP3 files and index data thereof being stored in a pre-determined region of the hard disk, this simplifies a data/file retrieval process performed by the MP3 controller of the MP3 player, and reduces requirements in process speed of the MP3 controller and memory capacity of a read-only memory (ROM) of the MP3 player, making overall fabrication costs desirably decreased.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A MP3 player, installed in a computer having a central processing unit, a hard disk and a sound output device; the MP3 player comprising:
a command input device for inputting a MP3-playing command;
a power control device for controlling power of the MP3 player, wherein the power control device outputs a MP3-playing signal upon receiving the MP3-playing command inputted by the command input device;
a bus switch device for switching connection of the hard disk from a bus of the computer to a player control device, when the bus switch device receives the MP3-playing signal outputted from the power control device; and
the player control device for retrieving and processing MP3 files stored in the hard disk, allowing the processed MP3 files to be outputted to the sound output device of the computer.

2. The MP3 player of claim 1, wherein the command input device is a plurality of predetermined keys on a keyboard of the computer.

3. The MP3 player of claim 2, wherein the predetermined keys are three keys for inputting commands of MP3_ON/MP3_OFF, PREVIOUS TRACK, and NEXT TRACK, respectively.

4. The MP3 player of claim 1, further comprising: a display device for displaying a playing status of the MP3 player, wherein the display device is a liquid crystal display module (LCM).

5. The MP3 player of claim 1, wherein the power control device comprises a power control chip and a power switch that is connected to a power source; upon receiving the MP3-playing command from the command input device, the power control chip outputs the MP3-playing signal to the bus switch device and the power switch, whereby the bus switch device is urged to operate, and the power switch is prompted to supply power from the power source to the hard disk and sound output device of the computer and internal devices of the MP3 player.

6. The MP3 player of claim 1, wherein the bus switch device is a multiple-to-one multibus switch.

7. The MP3 player of claim 1, wherein the bus switch device is a two-to-one multibus switch.

8. The MP3 player of claim 1, wherein the player control device comprises a MP3 controller for retrieving MP3 files from the hard disk, a MP3 decoder for decoding the MP3 files into digital signals, and a digital analog converter for converting the digital signals into analog signals.

9. The MP3 player of claim 8, wherein the MP3 controller further comprises a read-only memory (ROM) for storing a control program.

10. A MP3 player, installed in a portable computer having a central processing unit, a hard disk, a memory card, and a sound output device; the MP3 player comprising:
a command input device for inputting a MP3-playing command;
a power control device for controlling power of the MP3 player, wherein the power control device outputs a MP3-playing signal upon receiving the MP3-playing command inputted by the command input device;
a memory card bus switch device for switching connection of the hard disk from the memory card of the portable computer to a player control device, when the memory card bus switch device receives the MP3-signal outputted from the power control device; and
the player control device for retrieving and processing MP3 files stored in the hard disk or the memory card, allowing the processed MP3 files to be outputted to the sound output device of the portable computer.

11. The MP3 player of claim 10, further comprising: an IDE (Integrated Device Electronics) bus switch device for switching connection of the hard disk from an IDE bus of the portable computer to the player control device, when the IDE bus switch device receives the MP3-playing signal outputted from the power control device.

12. The MP3 player of claim 10, wherein the command input device is a plurality of predetermined keys on a keyboard of the portable computer.

13. The MP3 player of claim 12, wherein the predetermined keys are three keys for inputting commands of MP3_ON/MP3_OFF, PREVIOUS TRACK, and NEXT TRACK, respectively.

14. The MP3 player of claim 10, further comprising: a display device for displaying a playing status of the MP3 player, wherein the display device is a liquid crystal display module (LCM).

15. The MP3 player of claim 11, wherein the power control device comprises a power control chip and a power switch that is connected to a power source; upon receiving the MP3-playing command from the command input device, the power control chip outputs the MP3-playing signal to the IDE bus switch device, the memory card bus switch device and the power switch, whereby the IDE bus switch device or the memory card bus switch device is urged to operate, and the power switch is prompted to supply power from the power source to the hard disk, memory card and sound output device of the portable computer and internal devices of the MP3 player.

16. The MP3 player of claim 11, wherein the IDE bus switch and the memory card bus switch are each a multiple-to-one multibus switch.

17. The MP3 player of claim 11, wherein the IDE bus switch and the memory card bus switch are each a two-to-one multibus switch.

18. The MP3 player of claim 10, wherein the player control device comprises a MP3 controller for retrieving MP3 files from the hard disk or the memory card, a MP3 decoder for decoding the MP3 files into digital signals, and a digital analog converter for converting the digital signals into analog signals.

19. The MP3 player of claim 18, wherein MP3 controller further comprises a read-only memory (ROM) for storing a control program.

20. A method for operating a MP3 player, comprising the steps of:
installing a MP3 player in a computer having a central processing unit, a hard disk and a sound output device, wherein the MP3 player comprises a command input device, a bus switch device and a player control device;
storing MP3 files in the hard disk of the computer;
inputting a MP3-playing via the command input device;
switching connection of the hard disk from a bus of the computer to the player control device via the bus switch device, when the bus switch device receives the MP3-playing inputted by the command input device; and
retrieving and processing the MP3 files stored in the hard disk via the player control device, allowing the processed MP3 files to be outputted to the sound output device of the computer.
